(19) United States
(12) Patent Application Publication
(10) Pub. No.: US 2025/0339805 A1
(43) Pub. Date: Nov. 6, 2025

(54) AN AUTOMATED AIR FILTRATION SYSTEM FOR CONTINOUS REMOVAL OF AEROSOLS

(71) Applicant: ENBIOADVICE PTY LTD, Crace (AU)

(72) Inventor: Rama Heidari, Crace (AU)

(73) Assignee: ENBIOADVICE PTY LTD, Crace (AU)

(21) Appl. No.: 18/864,695

(22) PCT Filed: May 11, 2023
(86) PCT No.: PCT/AU2023/050391

§ 371 Date: Nov. 11, 2024

(30) Foreign Application Priority Data
May 13, 2022 (AU) 2022901276

(51) Int. Cl. B01D 46/62; B01D 46/00; B01D 46/90

(52) U.S. Cl. CPC B01D 46/62; B01D 46/0032; B01D 46/0086; B01D 46/90

(57) ABSTRACT

An air purification system comprising a housing having an internally formed air stream flow path communicating between an inlet for incoming polluted air containing particulate material and an air outlet for emitting clean filtered air from which the particulate material has been removed, a collection system provided in the air stream flow path to collect the particulate material, said collection system comprising at least three stages of filters positioned in series in a gradient arrangement in filter pore size and each stage having two identical filter elements in parallel arrangement (twin filter elements), the said three stages of gradient arrangement comprising a first coarse filter set, a second medium filter set and a third fine filter set, each of the said twin filter elements incorporating a means for automated clogging detection, automated self-cleaning, automatically self-removing from the airflow path and automatically switching to the clean filter of the twin filter elements, a means for allowing filtering stages to ensure continuous airflow while the filter cleaning mechanism is being used and only a single filter element of the twin filter elements exposed to the air flow path within the housing and functioning at any time, wherein, in operation, once a filter element is clogged, it is taken off the filtration air flow pathway by triggering the self-cleaning mechanism and at the same time engaging the second twin filter element to take over the filtration process in that the passage of air through the filter housing is facilitated by a set of inline suction fans located downstream side of each filter stage of the air flow path where the passage of sufficient air volume through the fans is controlled by a pre-set airflow sensor connected to fans for automated adjustment of the air flow to ensure sufficient airflow constantly.

### FIELD OF THE INVENTION

As we learn to live with a heightened awareness of airborne viruses such as COVID-19 and other air contaminants such as smoke and dust from bushfires people are seeking ways to effectively clean and improve the quality of air in our homes, schools and workplaces. As such air purifiers and air filtering systems are growing in popularity and there is a significant demand for efficient air cleaning apparatus. The present invention relates to such an apparatus for cleaning air highly efficiently using a combination of filters to remove micro particles and pathogens. The air filtration system of the present invention requires very little maintenance and is capable of self-cleaning while ensuring a continuous clean air supply.

### BACKGROUND

Polluted breathing air is a main underlying issue for respiratory health problems worldwide according to the World Health Organisation and the Environment Protection Authority. Recent large-scale scenarios such as airborne infectious diseases and the atmospheric and anthropogenic activities generating aerosol laden particulate matters (PM) lead to air pollution with undeniable worldwide health and economic impacts. If untreated, long-term exposure to poor air quality can lead to reduced lung function and breathing problems as well as lung cancer and ultimately cardiovascular-related mortality. While these are the main focus of ongoing global efforts to mitigate the long-term severities, the air quality seems to worsen nonetheless as populations grow and civilizations advance. It is evident that treatment of related diseases incurs government, tax payers and the society significant cost through increased demand for health services and medications. This invention introduces a low-maintenance air filtration system for producing improved air quality which is suitable for preventing health-related problems resulting from airborne particles.

With regard to the current and future airborne infectious diseases such as SARS Cov2, science explains the mechanisms of transport of these infections to be via droplets exhaled by an infected person which can travel in the air tens of meters away. There is evidence that this is a significant route of infection in indoor environments. It is therefore extremely important that the national authorities acknowledge the reality of future similar virus variants spreading through air, and implement effective measures to prevent further spread of the virus, in particular removal of the virus-laden droplets from indoor air by adequate ventilation.

PM is the generic term for a broad class of chemically and physically diverse substances that exist as discrete particles (liquid droplets or solids) over a wide range of sizes. Generally, the air is considered polluted if the ambient concentration of fine particulate matter (i.e. PM2.5 aerodynamic diameter≤2.5 μm) exceeds 75 μg/m³ of breathing air. Particles may be emitted directly or formed in the atmosphere by transformations of gaseous emissions such as sulphur oxides (SOX), oxides of nitrogen (NOX), ammonia (NH3) and volatile organic compounds (VOCs). Their chemical and physical properties vary greatly with time contributing to the secondary particle formation. It is known that many natural or artificial factors may alter both the size and the electrical charge of aerosols. Examples of factors include cosmic rays in space, radiation from radioactive material in air and on earth, atmospheric lightning, electromagnetic radiation, high temperature discharge and static electricity caused by particles collision. Studies on human respiratory deposition of particles have shown that at an average inspiratory flow rate of 1.2 m³/hr [0.7 Ft³/min], particles with aerodynamic diameter of >0.5 μm and 2-5 μm have the highest deposition fractions. In addition, smaller particles have been found to be more susceptible to the electrostatic interactions with the surrounding particles charges.

Science has shown that exposure to air pollution may originate from sources inside the buildings (for example, inside homes, schools, and other indoor spaces). Indoor air pollutants from biological sources such as mould; dust mites; pet dander (skin flakes); and droppings and body parts from cockroaches, rodents, and other pests or insects, can lead to allergic reactions, exacerbate existing asthma, and promote other respiratory symptoms which can have a significant health impact. PM and NO₂, discussed previously as outdoor air pollutants, also pollute indoor air when they are emitted from gas stoves, gas or oil furnaces, fireplaces, wood stoves, and kerosene or gas space heaters. Indoor concentrations of these combustion by-products can reach very high levels especially during the winter when use of fireplaces and space heaters is more common. Intermolecular interactions between pollutants as gas or aerosols can affect their stability and traveling by the air movement indoors.

A general understanding of some of the basic principles and problems of filter design can be used when deciding on the filtration method. For example, in case of mechanical filtration, as the filter will act to remove the particles from the gas stream (with substantial amounts of particulate material above the “selected size” therein) the particles are collected as a dust cake, on the upstream side of the mechanical filter. This eventually substantially occludes the filter to the passage of air therethrough, which leads to the pressure differential across the filter sides (i.e. pressure-drop).

A variety of air filter or gas filter arrangements have been developed for particulate removal as shown in the Table 1 below. One of the common methods of PM removal from indoor spaces is using air-purifiers relying on either HEPA filters or ozone-based technology. However, as explained in Table 1 below HEPA filters in long term prove to be costly in maintenance while the ozone-based purifiers have been found to impose harmful effects on human health. The present invention is aimed at providing a more efficient system which addresses the disadvantages of the prior art systems. The Table 1 below provides a comparison of the commercially available filtration devices.

TABLE 1
(Comparison of the commercially available methods
for removal of aerosol particulate matters in air):

| Method description | Highlights | Limitations |
|---|---|---|
| (i) Fibrous filters | Suitable to collect fly | The required cleaning |
| | ash from low-sulphur | intensity and frequency |
| | coal or fly ash | affects the removal |
| | containing high levels | efficiency, pressure |
| | of unburnt carbon. | drop and energy |
| | Fibrous filters are | requirement. |
| | known for removal of | environmental impact |
| | particles from | due to replacement and |
| | contaminated air. | disposal of the used |
| | | filters. |
| | | are extremely fragile |
| | | and can easily be |
| | | damaged during |
| | | installation, cleaning, |
| | | and even when the unit |
| | | is . . . |
| | | HEPA units are usually |
| | | loud. |
| | | are costly to operate - |
| | | in energy usage. |
| (ii) Activated carbon | A composite fibrous | As above. |
| loaded fibrous filters | filter with activated | |
| | carbon powder. | |
| | [Activated carbons | |
| | are used for the removal | |
| | of volatile organic | |
| | compounds (VOCs)]. | |
| (iii) Composite | Known as diesel | Designed specifically |
| ceramic filters with | particulate filters; | for use in diesel |
| oxidation catalyst | (these are Coated | engines, in order to |
| (implemented more | filters with oxidation | obtain a lower back |
| in automotive | catalysts for removal of | pressure and a blocking |
| industry) | the PM2.5 contaminants | risk they need to be |
| | (with different low | adjusted to capture |
| | temperature catalysts | only 70% of the |
| | used depending on the | contaminants load. |
| | organic or inorganic | |
| | composition of the PMs | |
| | to be removed). | |
| (iii) Centrifugal | exploiting centrifugal | primarily used to |
| cyclones. | forces through conical | capture particles over |
| | | PM10. |
| | chambers. | used as pre-cleaners |
| | | for more expensive |
| | | final control devices |
| | | such as fabric filters |
| | | or electrostatic |
| | | precipitators. |
| (iv) Wet scrubbers | interception of PM | the main disadvantages |
| (WS) | through the direct | of WS are: the risk of |
| | contact with liquid | corrosion and freezing, |
| | droplets. | the generation of a |
| | Liquid scrubbers are | liquid by-product and |
| | used in case of | the low particle |
| | removal/recover of | collection efficiency |
| | flammable and explosive | in the 0.1-2 μm |
| | dusts as well as | range. |
| | treatment of gaseous | |
| | compounds. | |
| (v) The Electrostatic | (ESP) utilizes | Main disadvantages are |
| precipitator (ESP) | electrical forces to | related to the |
| utilizes electrical | move particles in gas | maintenance of the high |
| forces to move | streams into collector | voltage generation |
| particles in gas | plates. | (electrodes cleaning) |
| streams into | High removal efficiency | as well as the danger |
| collector plates. | and low pressure drop. | of dust explosion after |
| | | discharges. |
| (vi) Cloud Chamber | Advanced type of ESPs. | Maintenance costs can |
| Scrubber | For removal of dust and | be high - Horsepower |
| | emissions from heavy | requirements and |
| | manufacturing | pressure-drop |
| | industries. | requirements are |
| | | relatively high unless |
| | | you purchase a portable |
| | | system, which likely |
| | | won't accommodate your |
| | | needs. |
| | | It's possible for |
| | | solids to build up |
| | | around the wet-dry |
| | | interface, which can |
| | | create maintenance |
| | | problems. |
| | | The accumulation of |
| | | collected water can |
| | | make the system very |
| | | heavy. |
| (vii) non-HEPA air- | Use ozone. | Exposure to ozone |
| purifiers | | imposes health risk in |
| | | long term. |

The patent specification CN112403125 discloses an air filtration system for removing airborne particles. However, the apparatus disclosed in CN112403125 has several disadvantages. One of the main disadvantages of the system disclosed in CN112403125 is the apparatus cannot provide a continuously supply of clean air without impacting the filtration efficiency and flow due to clogging up of the filters. The apparatus cannot be used during the de-clogging process as it does not provide a self-cleaning mechanism while continuing to provide a stream of clean air. In addition, the above system uses ash blowing devices to clean filters which can be less efficient or use a catalytic method being a costly option.

The present invention aims to address inherent deficiencies of the prior art systems for removal of airborne pathogens and pollutants without a need for regular component replacement thereby minimising any impact on environment while improving the efficiency, consistency, and cost of servicing larger spaces. The present invention can be implemented with renewable resources such as solar and ceramics combined with advances in nanoengineering, providing a higher standard of air quality suitable for a variety of spaces. The air cleaning system as defined in the present invention adsorbs hazardous aerosol compounds from the atmosphere and produces pollutant-free breathing air efficiently and using renewable resources. It relies on three main technologies:
(a) Sustainable production of silica filter plates (composite porous ceramics) with tailorable morphology, specific surface areas and pore sizes. The pore sizes within the range of 10 nm to 2.5 μm plus the enhanced chemical and physical stability of the composites enable this technology to efficiently capture airborne pathogens and PM2.5 pollutants and become a viable component of future healthy and energy efficient spaces.
(b) Solar supported automation (electric valves and pressure-drop sensos) and ventilation (inline electric fans): This part of proposed work relies on a fully solar electronic programmed system to facilitate the flow of outside air over the porous surfaces of filtering gradient using renewable energy.
(c) Built-in system clean-up and pollutant disposal technology: One advantage of the proposed product compared to those commercially available systems is that the collected pollutants will not return to the environment as it does not involve any filter which normally have limited life span. The hazardous aerosols collected by the proposed technology will be disposed of (under relevant EPA recommendations) by an in-built wash & collection program all supported by the self-generated power.

### SUMMARY OF THE INVENTION

In order to overcome the drawbacks of the prior art air purification systems, the present invention defines an air purification system that comprises the following features.
a housing having an internally formed air stream flow path communicating between an inlet for incoming polluted air containing particulate material and an air outlet for emitting clean filtered air from which the particulate material has been removed;
a collection system provided in the air stream flow path to collect the particulate material;
said collection system comprising
at least three stages of filters positioned in a gradient arrangement and each stage having two identical filter elements (twin filter elements)
each of those twin filter elements incorporating a means for self-cleaning; and
a means for allowing filtering stages to ensure continuous airflow while the self-cleaning mechanism is being used.

The key features of the present invention are the provision of a means for self-cleaning the clogged filter surfaces, and providing a twin-filter arrangement to allow continuous airflow while the means for self-cleaning are in operation. To achieve this, the apparatus of the present invention consists of two exact twins for each type of filter element within the air flow path with only one filter element of the twin filter element functioning at any time. Once the first filter is clogged it is taken off the filtration air flow pathway via an automated communication between the electric parts which triggers the self-cleaning mechanism. At the same time the second twin filter will take over the filtration process. This prevents any interruptions in the filtration process.

The present invention has several advantages over the prior at. The key differences between the present invention and the prior art are:
(i) High efficiency (>95%) in removal of the particulate matter and aerosols in the range of 2.5 μm-5 μm.
(ii) Combining advanced capabilities of automated filtration, fan-assisted flowrate-vs-pressure differential aerodynamics and the porous ceramics manufacturing.
(iii) Higher specificity due to consistent pore sizes to capture both pathogen aerosols and PM2.5 (particulate matters) in air.
(iv) High regeneration capacity and lowest maintenance requirement as no filter waste is produced due to automated self-cleaning of filtering elements and their chemical stability against solvents.
(v) Exploiting the interaction between particles electrostatic charges and size and physical behaviour to maximised the filtering efficiency without the need for a high-voltage usage.
(vi) Gradient arrangements between filter elements provides an assurance to elongate the useful lifetime of the system.
(vii) Advantage of constant data monitoring from atmospheric pollution sensors (airborne PM and pathogens) resulting in more efficient removal of pollutant laden aerosols when needed.
(viii) Contrary to the prior art filtering methods (which loose effectiveness due to poor adsorbent regeneration capacity and other problems related to the disposal of the end-of-life sorbent), ceramics are sourced from renewable alumina/silica which are abundant in nature and even can be recycled (as a by-product derived from ferrosilicon or silicon metal alloy processing) as well as the automated self-cleaning of filtering elements.
(ix) The device can be engineered to any desired geometry and will allow widespread application to suite any building spaces and applications. This may serve to support clinically critical spaces to accommodate patients with respiratory and or cardiovascular sensitive background and/or in response to pandemic or bushfire issues.

### DETAILED DESCRIPTION OF THE INVENTION

The main features of the present invention are discussed below in further details.

The air cleaning system of the present invention comprises a combination of filters positioned in a gradient arrangement. The filter elements are arranged in series (several consecutive steps) with each filter incorporating a different filter material and having a specific pore size for removal of specific particulate matters with larger pore size filters being responsible for removal of the larger PM in the early stage of the process. In one of the preferred embodiments, a ceramic filter having smallest pore size is located last in the downstream of the device (that is the last filter in the filtration device). This allows for high efficiency in removal of the fine aerosols. The alternative filter material may include (but not limited to) a thermosettable polyalkylene derived material which may be (but not limited) made in a coil or pleated shape and is resistant to corrosion by airflow and most industrial solvents.

Another key feature of the present invention is a means for automated self-cleaning which is activated when the filter surface is clogged by the collected particulate matters. The means for automated self-cleaning comprises:
(a) A pressure drop-activated sensor positioned on downstream side of the filters compared to the airflow direction.
(b) A first electric valve located on the downstream side of the filters compared to the airflow direction. The first electric valve is coupled with the pressure-drop sensor mentioned above.
(c) A second set of electric valve located on the upstream side of the filters and in communication with the first valve. Both electric valves and the sensor are activated once the filter surface is clogged by a signal from the sensor due to the pressure drop caused by the clogged filter. Once activated, both electric valves tightly block the air pathway (air duct) and take the clogged filter off the filtration process. This means the clogged filter will not engage in the filtration until its cleaning process is completed and that the de-clogging process happens in an air-tight space.
(d) A third electric valve is located at the bottom of each filter compartment to drain any wastewater produced during the cleaning process.
(e) A set of electric washing spray jets located on different sides of filter surfaces. For the larger pore size filters, the electric spray jets are located on the downstream side of the airflow spraying on the opposite direction of the airflow. For the filters with fine pore size (such as ceramic filter with 5 μm pore size) the spray jets are located on the upstream side of the filter spraying on the ceramic filter surface in the airflow direction. Electric spray jets are in communication with the drain electric valves and are activated with pre-set time-delay compared to the first set of the electric valves. This means at the start of the filter de-clogging process the first and second valves are activated and block the air duct from the airflow. Then after few seconds-delay both the electric spray jets and the electric drain valve are activated become open and drain away the wastewater for a set period and complete the filter-cleaning process. At completion of the cleaning process both electric jet and electric drain valve are back to their closed-off position and stay closed de-activated along with the first and the second electric valves and the then cleaned filter itself which remain un-engaged in the filtration until the next signal by pressure-drop sensor is received.

Yet another key feature of the present invention is the use of twin-filter elements (duplicate filters). For each of filters in the gradient filter arrangement there is an exact twin filter element which will replace the first filter-set once the first filter is clogged and is taken off the filtration process via the activation of the first and the second set of electric valves. The air passage for each of the twin elements can be either closed or open automatically by use of the electric valves.

The passage of air through the filter housing is facilitated by a set of inline suction fans located at different positions of the air flow path. The fans are located at the end of the air outlet connected to relevant air-void on the downstream side of each filter set. This means that the air-void for each filter set collects the filtered air. Each air-void is shared between the reserved twin filter and the working filter and has opening for each of these filter sets. The said openings have the first electric valve and the sensor for measuring the pressure-drop across each set of filters. This ensures a continuous stream of airflow.

The purpose of the air-void is to help with even distribution of vacuum force created by the suction fan and to support the corresponding filter to function more efficiently in removal of the particulate matter specific to its pore size. It also plays a role as a connector for the passage of the air from one filter in the gradient system with larger pore size through the suction fan onto the next filter in the gradient system with the smaller pore-size.

The inline fans of the present invention are designed to create continuous air flow and may be shared between the twin filter set and the working filter set. This means one inline fan may be connected to each air-void which is shared between the twin filter elements and the working filter set and consequently can serve the functioning filter at the time.

The continuous functioning of the inline fans facilitates ongoing positive pressure for the corresponding rooms to which they supply air and consequently protect the indoor from the polluted atmospheric air entering inside. The fans are designed to be energy efficient and cost effective even if they rely on the grid but also may be powered by renewable cost-effective energy such as solar.

### DETAILED DESCRIPTION OF THE INVENTION WITH REFERENCE TO DRAWINGS

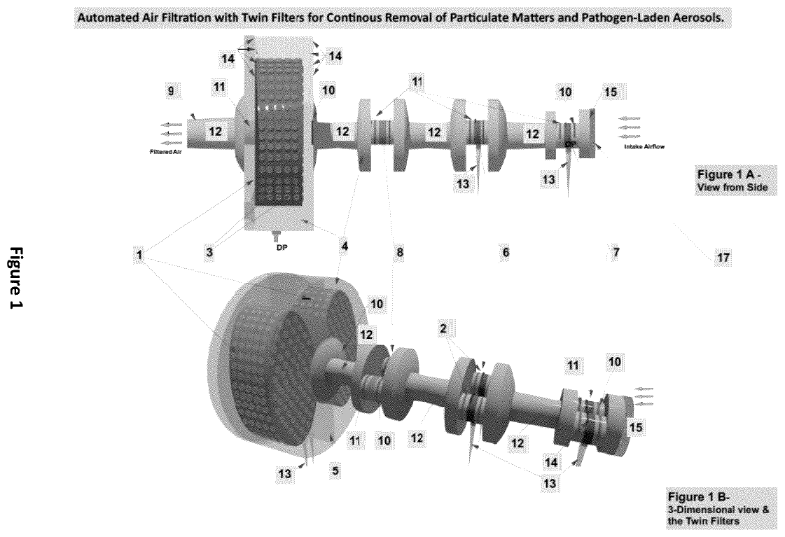

A preferred embodiment of the novel air filtration system of the present invention is further described below with reference to the FIGS. 1-13.

FIG. 1 is a schematic three-dimensional illustration of the present invention showing each component of the gradient hybrid filtration system.

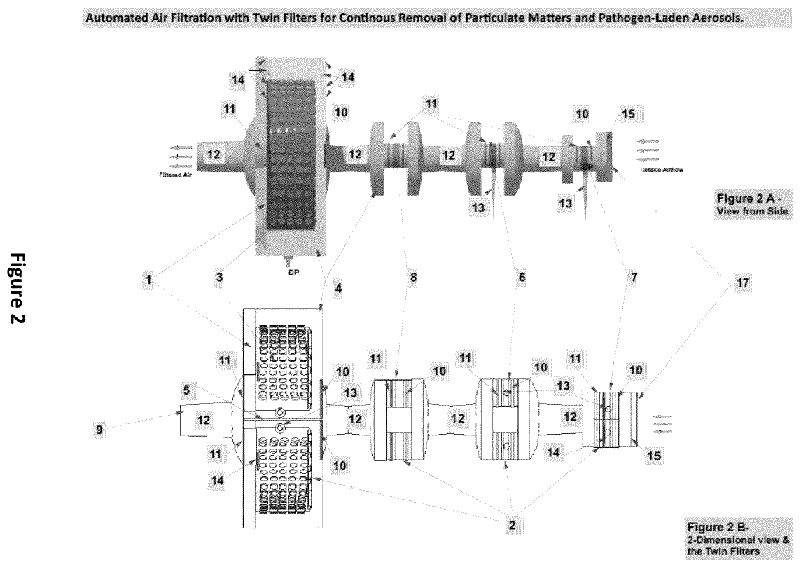

FIG. 2 is a schematic two-dimensional illustration of the present invention showing each component of the gradient hybrid filtration system.

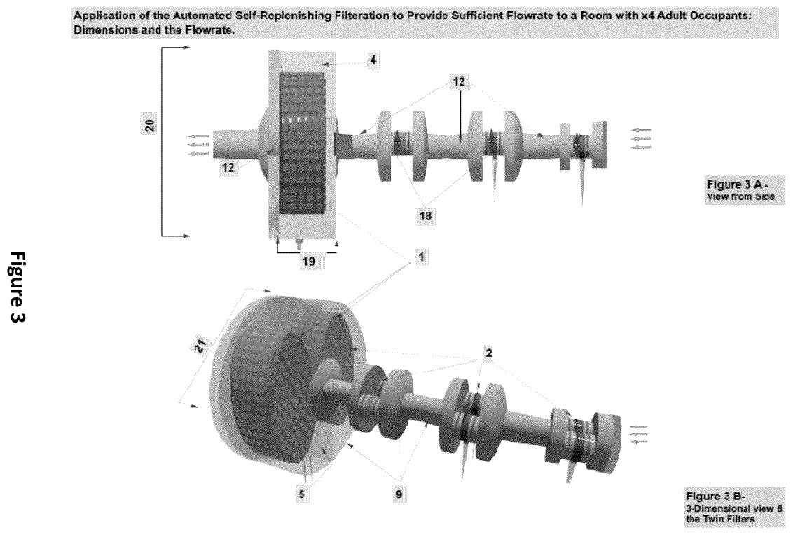

FIG. 3 is an embodiment of the present invention illustrating suitable dimensions of the device suitable for creating sufficient airflow for an office with four adult occupants. This illustrates the effect of the size and thickness of the individual ceramic discs on the overall size of the ceramic module. The fixed parameters between comparisons are: the pore size (4-5.5 μm), overall flowrate (83 CFM) supply corresponding to x4 adult occupants as per regulatory requirements.

FIG. 4: is a schematic illustration of the Component 2 and 3 Filters of the proposed ventilation devices showing each filter element of the twin filters and air flow passage.

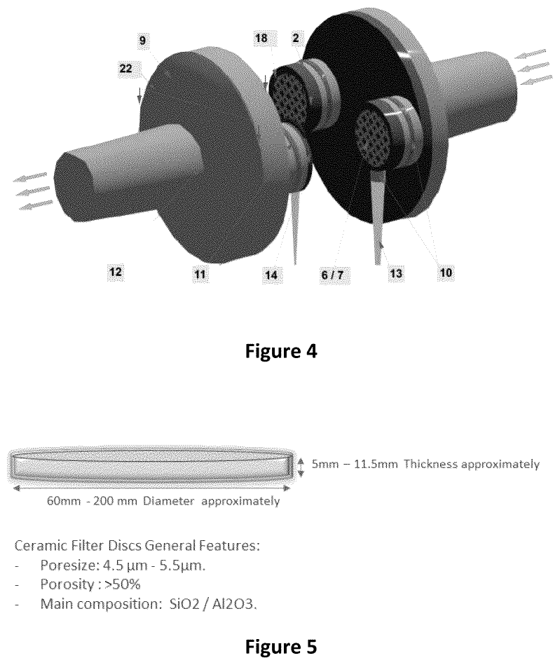

FIG. 5: is an illustration showing details of an individual ceramic filter disc.

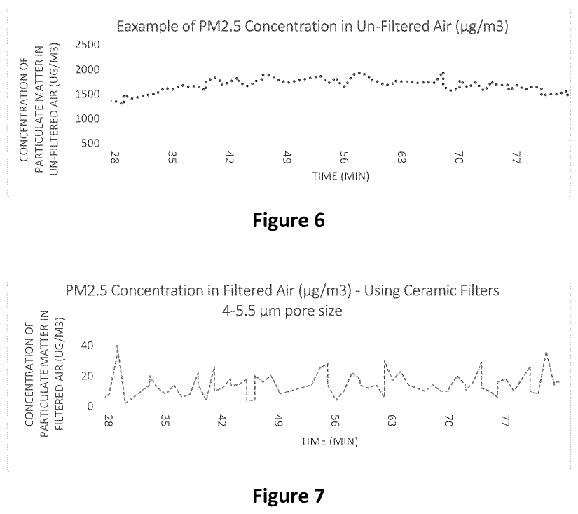

FIG. 6: is an example of Particulate Matter PM 2.5 μm concentrations in the air before filtration via ceramic filters (4-5.5 μm pore size) at air flow rate of 120 fpm (103 CFM).

FIG. 7: is an example of Particulate Matter PM 2.5 μm concentrations in the air after filtration via ceramic filters (4-5.5 μm pore size) at air flow rate of 120 fpm (103 CFM).

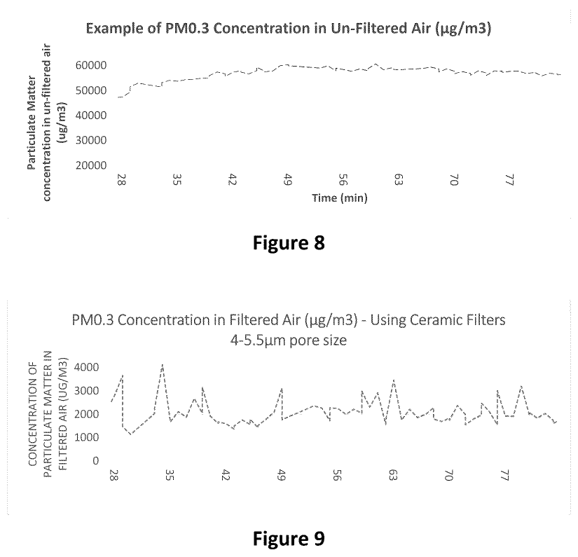

FIG. 8: is an example of Particulate Matter PM 0.3 μm concentrations in the air before filtration via ceramic filters (4 μm pore size) at air flow rate of 120 fpm.

FIG. 9: Example of Particulate Matter PM 0.3 μm concentrations in the air after filtration via ceramic filters (4 μm pore size) at air flow rate of 120 fpm.

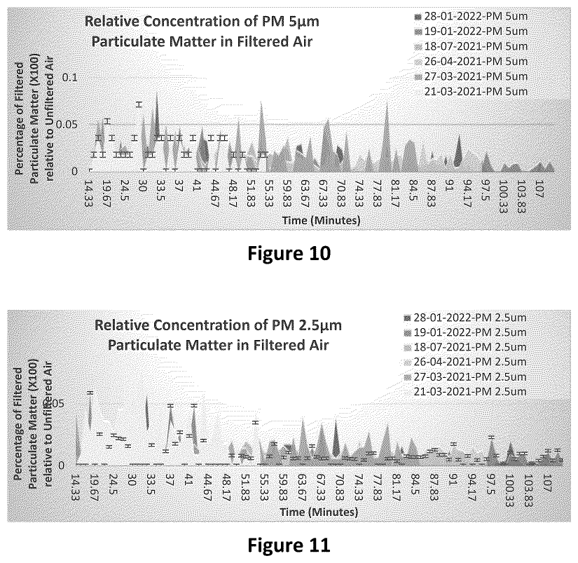

FIG. 10: is an illustration showing filtration efficiency of ceramic filters between independent experiments; Percentage of filtered 5 μm particulate matter relative to unfiltered Air. The lower the concentration of the PM in the filtered air means the higher efficiency of the filtration. The particulate matters PM5 μm in the filtered air amounts only for <5% of the total contents of the PM in the un-filtered air.

FIG. 11: is an illustration showing filtration efficiency of ceramic filters between independent experiments; Percentage of filtered 2.5 μm particulate matter relative to unfiltered Air. The lower the concentration of the PM in the filtered air means the higher efficiency of the filtration. The particulate matters PM2.5 μm in the filtered air amounts only for <5% of the total contents of the PM in the un-filtered air.

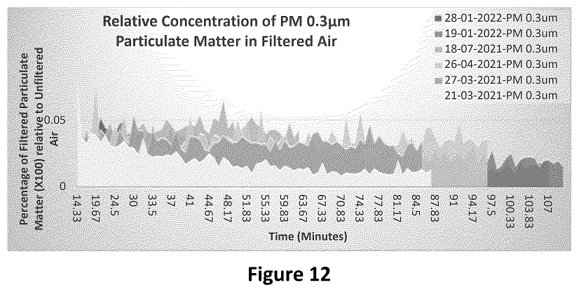

FIG. 12: is an illustration showing filtration efficiency of ceramic filters between independent experiments. The particulate matters (PM0.3, PM2.5, PM5 μm) in the filtered air amounts only for <5% of the total contents of the PM in the un-filtered air.

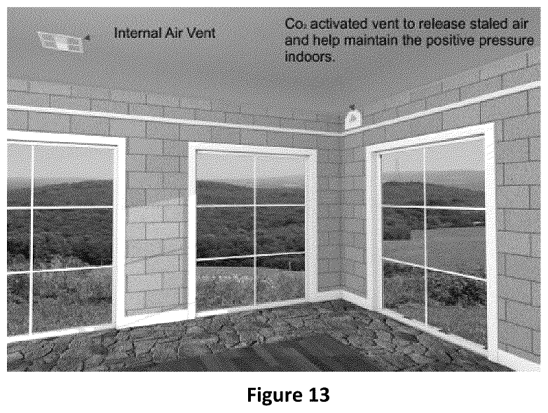

FIG. 13: is an illustration of position of the CO₂ activated vent as optional part of the invented device. The effectiveness of the ventilation process by the invented device may be improved if the room is equipped with a CO₂ sensor coupled with an automated vent above a wall to release the staled air and help to maintain the positive pressure inside the ventilated room.

As shown in FIGS. 1, 2 and 3 a large number of individual ceramic filter disks (3) are installed within each ceramic filter holder(1). A set level of the flowrate and large ceramic surface area are required to overcome the pressure differential caused by the ceramic micro size of the pores of the ceramic filters. The required flowrate is supplied by an internal suction fan located downstream side of the ceramic filter holders(1). The ceramic filter holder 1 contains Air-Void (4) for an even distribution of air within the ceramic filter holder (1). A partition (5) is positioned between the two main ceramic filter holders to maintain the twin filters airtight and separated from each other. As shown in FIG. 3, each of the filtering stages comprises twin-filter sets (2). The filter component 2 (6) as shown in FIGS. 1 and 2 typically has a pore size of 12 μm. The filter component 3 (7) as shown in FIGS. 1 and 2 typically has a larger pore size of 37 μm. The electrostatic (pre-charged) filter (8) shown in FIGS. 1 and 2 is an optional feature. The housing or the outer protective capsule (9) as shown in FIGS. 1 and 3 is made of a lightweight insulated aluminium. As shown in FIGS. 1 and 2, electric valves (10) are positioned upstream of each of the filters. The electric valves coupled with a pressure drop sensor (11) are located downstream of each of the filters as shown in FIGS. 1 and 2. The Inline Suction Fans (12) are located downstream of each of the filters as shown in FIGS. 1 and 2. The drainpipes (13) coupled with a specific electric valve are located at the bottom of each filter set as shown in FIGS. 1 and 2. The electric spray jets (14) for filter cleaning. A Particulate Matter Sensor (15) is located just behind the front protective mesh (17). The front protective mesh (17) is for the purpose of removing larger coarse particles from the airstream.

FIG. 3 illustrates the application of the present invention for use in a typical room with four adults. As shown in FIG. 3, the diameter of the non-ceramic filter components in is 0.3 meter. The depth of the Ceramic Component is typically 0.73 meter. The Height of the Ceramic Component is 1.1 meters, and the diameter of the Ceramic Component is typically 1.6 meters.

As shown in FIGS. 1 and 2, air is drawn through the inlet via the front protective mesh and passes through several filter elements starting with component 3.

The component 3 in the present embodiment is made of a filter mesh #1200 element capturing PM with dimensions around 37 μm. This component can be made of aluminium mesh secured in an aluminium frame, or any other porous material a thermostable polyalkylene derived material which maybe (but not limited) made in a coil or pleated shape with a large air contact surface areas secured by a rigid material to avoid being collapsed and is resistant against corrosion by the airflow and industrial solvents. As shown FIGS. 1 and 2, the component 3 comprises a twin filter set. The pore size of this component can be any other size depending on the application and the desired outcome in terms of removal of any particular aerosols

The component 3 further comprises and electric valve (10) located pre filter and an electric valve coupled with a pressure drop sensor (11) located post-filter as shown in the FIGS. 1 and 2. In addition, component 3 further comprises multiple electric jets (14) for cleaning clogged filter elements and a drainpipe (DP) coupled with another electric valve for draining the cleaning fluid from the filter housing.

The filter element of the component 2 as shown in FIGS. 1 and 2 is made of a filter mesh #400 capturing PM with dimensions around 12 μm. This component can be made of aluminium mesh secured in an aluminium frame, or any other porous material a thermostable polyalkylene derived material which maybe (but not limited) made in a coil or pleated shape with a large air contact surface areas secured by a rigid material to avoid being collapsed and is resistant against corrosion by the airflow and industrial solvents. As shown in FIGS. 1 and 2, component 2 comprises a twin filter set. The pore size of this component can be any other size depending on the application and the desired outcome in terms of removal of any particular aerosols.

Component 2 similar to component 3, further comprises an electric valve (10) located pre filter and an electric valve coupled with a pressure drop sensor (11) located post-filter as shown in the FIGS. 1 and 2. In addition, component 3 further comprises multiple electric jets (14) for cleaning clogged filter elements and a drainpipe (DP) coupled with another electric valve for draining the cleaning fluid from the filter housing.

The component 1 as shown in FIGS. 1 and 2 is designed to capture smaller particulate matters with 2.5 μm to 5 μm diameter. The pore size of this filter is 4-5.5 μm. Component 1 comprises of the two twins of the ceramic filter holders comprising large ceramic surface areas (the sum of surface areas of a high number of individual ceramic filter discs) surrounded by large air-void and all contained within a capsule of insulated aluminium (FIGS. 1A and B). The air-void containing the pre-filtration air distributes the intake air evenly over the total surface of the ceramic filter discs supported by the ceramic filter holder. The ceramic filter holder can be insulated hallow metal connected to the inline fan. The alternative of the ceramic filter housing can be (but not limited to) a thermostable polyalkylene derived material which maybe (but not limited) made in a coil or pleated shape with a large air contact surface areas and its pore size corresponds to those of the current ceramic filters.

As shown in FIGS. 1 and 2, an inline fan (12) is located on the downstream side of the air void and the ceramic component in order to create sufficient airflow to overcome the pressure-drop created due to small size of filter pores (FIG. 2A).

As depicted in FIG. 3, the required flowrate of the fan (and the device) to suite a room with four adult occupants is equivalent to 74-83 FCM (Foot Per Minute). The details of the corresponding required scale of the device for this example are also presented in FIG. 3. However, the combination of the airflow and the scale of the device can be tailored to suit any type of geometry and sizes depending on the application.

A brief comparison between the final scale of the ceramic component influenced by the pore-size and thickness of the individual ceramic discs is presented in table 2 below. As shown in table 2 the smaller the thickness and diameter of the individual filter discs a more efficient airflow hence requiring less surface area which in our case is more desirable due to a more manageable size and overall cost of production.

TABLE 2
Effect of the size and thickness of the individual ceramic discs on the
overall size of the ceramic module
The fixed parameters between comparisons are: the pore size (4-5.5 um),
overall flowrate (83 CFM) supply corresponding to x4 adult occupants as
per regulatory requirements.

| Individual | | | Corresponding Overall |
|---|---|---|---|
| Ceramic | Individual | Required | Dimensions of the |
| Filter Discs | Ceramic Filter | Filter Surface | Ceramic Module |
| Thickness | Discs Diameter | Area | Height × Diameter × |
| (mm) | (mm) | (m2) | Depth |
| 5 | 60 | 1.04 | 1.1 m × 1.6 m × 0.74 m |
| 5.5 | 65 | 1.16 | 1.1 m × 1.6 m × 0.83 m |
| 6.5 | 90 | 1.52 | 1.2 m × 1.8 m × 0.95 m |
| 8.5 | 120 | 1.84 | 1.2 m × 1.8 m × 1.08 m |

The preferred embodiment of the present invention may include an Electrostatic (pre-charged) filter (8) subject to the relative humidity of the atmosphere as shown in FIGS. 1 and 2. The said filter in the present invention can be made in any type of geometry and is a flat filter fabric of a polypropylene nature secured in an aluminium frame and simple to be replaced manually. The reason for non-automated facility in this component is that the washing and drying process of a polypropylene fabric requires longer time to complete. Therefore, manual replacement deems to be more suitable at this stage. However, any pre-charge filter material with more hydrophobicity could potentially be a better alternative and subsequently make this filter more suitable for automation.

Finally, as shown in FIGS. 1 and 2, a sooth sieve plate (17) is also located at the front of the device before the intake air reaches the Component 3. The purpose is to make the initial load of the larger particulate matter in the intake air less before the intake air is subject to intensive filtration by the device.

The arrangement of the self-cleaning components of the present invention is shown in FIGS. 1 and 2 and is described with reference to those figures below:
(a) Filter cleaning is required in order to obtain a lower back pressure and a blocking risk, as well as supporting the continuity of filtering operation.
(b) The present invention comprises of two exact twins of each individual filter component hence one twin is always operating while the other is being cleaned and de-clogged (by means of an automated washing-system).
(c) The wash-system comprises a set of electric jet sprayers coupled with a pressure-drop sensor. Electric jet sprayers are activated by means of the signal from the airflow Sensor (pressure-drop sensitive). The Sensor is coupled with an Electric valve (named first electric valve) and positioned behind all Filters including Ceramic component 1 and the filter components 2 and 3. The pressure-drop sensor coupled with the first electric valve are located downstream ide of the filter surface.
(d) Each filter having a different pore size captures specific particulate matters lager than their pore size at a different rate. Filters continue to accumulate particulate matters to a certain level (on their upstream side) until there is a pressure-drop across the filter to some defined level for that particular filter. At that stage that particular filter has reached its useful life of efficient filtration hence requiring clean-up for the whole filtration system to be able to continue operation.
(e) A pressure-drop sensor positioned on the downstream side of each filter is coupled with an electric valve which becomes activated once the pressure-drop has increased and reached a defined level for that particular filter meaning that filter is clogged and requires cleaning. This activates the Electric Valves on both side of that particular filter to close-up and air-sealed both upstream and downstream sides of the said filter. This simultaneously activates the Twin Filter to take-over the filtering operation (FIG. 1-B).
(f) The activation of the twin filter begins by the simultaneous opening of the corresponding electric valves (type 1 and 2 electric valves) on both sides of the twin filter. The opening of the said valves causes airflow being directed into the clean element of the twin filter without any interruption to filtering operation and airflow while the blocked filter is being cleaned.
(g) The process of cleaning of the blocked filter: as mentioned in the “Automated de-clogging” above, the pressure drop Sensor's signal activates the two “Electric Valves” (type 1 and 2 electric valves) automatically which are located at the two ends (upstream and downstream of the airflow direction) of each twin system, isolating the section to be washed from the rest of the operating filtration.
(h) The electric jets are responsible for washing of the blocked filters. The electric jets are located in two different locations relative to filters: for the Component 1 ceramic filter the electric jets are located on the upstream of the filter side while for the Components 2 & 3 mesh filters the electric jets are located on the downstream of the filter side. This arrangement is to back wash the mesh filters by pushing water in the opposite direction of the airflow to filters so the clogging PM can be forced from the back of filters to clear the face.
(i) For the ceramic filters the electric jets sprays water on the same side of the filter due to micro-scale pore-size of the filter and resistance to water flow. Thus, as per manufacturers recommendation the face wash (same side of airflow direction) is more effective in removal of clogged PM from the face of ceramic filters.
(j) Activation of the electric jets is also synchronised by opening of another set of the electric valves which open the drainpipes located at the bottom of each filter. Each wash cycle will take approximately 10 minutes. At the end of wash cycle all the electric valves and electric wash jets return to their inactivated modes and electric valves remain closed keeping the cleaned filter protected. This arrangement is continuous until a signal from the twin sensors of the operating filter element indicates that operating filter element is blocked, hence activating the wash cycle for the blocked filter element s and reinstating the cleaned filter element of he twin filter.
(k) The nature of all electric valves is such that when they are not in use they will remain air-tight hence to avoid the leakage of the filtered air to the surroundings.

In accordance with this invention, constantly produced positive pressure indoors maintains indoor spaces protected from the surrounding environment. This positive pressure inhibits the atmospheric contaminants and particulate matters from entering into the protected spaces.

In the present invention the supply of positive pressure and sufficient airflow is facilitated by a set of inline suction fans located at downstream side of each filter stage. The passage of sufficient air volume through the fans is controlled by a pre-set airflow sensor connected to fans for automated adjustment of the air flow. Therefore, the system is capable of ensuring positive pressure and sufficient air is constantly provided.

As shown in FIG. 13 the effectiveness of the ventilation process by the invented device requires the room to be equipped with a CO₂ sensor coupled with an automated vent above a wall to release the staled air and maintain the positive pressure inside the ventilated room.

The invented system makes possible continuous filtering operation while reducing the load on the filter membranes and performing effective self-cleaning. The ongoing filtering capability of the invention relies on the continuous positive differential pressure created in an array of inline fans (energy-cost effective) and automated de-clogging of the system. The cost of automated operation of the system is negligible as shown in Table 3 below. The cost of running each of the electric components of the present invention is shown in Table 3.

The present invention can also be used in an alternative arrangement for recycling indoor air to eliminate any residual PM contaminants in the indoor space. This arrangement is useful for dealing with those contaminants which potentially enter the indoor space via the leakages in the building or those created by the indoor activities of the occupants such as the PM due to cooking oil or from the heating appliances. Instead of using multiple filters as discussed previously, just one twin filter can be used for these purposes. For example, indoor air filtration may require only the Component 1 or a combination of the gradient filters. They can be manufactured to any size and geometries as required.

To improve the effectiveness of the ventilation process of the present invention it would be useful for the room to be equipped with a CO₂ sensor coupled with an automated vent above a wall to release any staled air and maintain a positive pressure inside the ventilated room (FIG. 9).

Among the atmospheric factors, the effect of humidity on PM mean diameter has been a subject of interest for many researchers. It has been shown that the agglomeration rate of particles would increase with a rise in the atmospheric humidity due to the increased liquid bridging forces that enhance the agglomeration velocity which could affect the electrostatic interactions between particles. In general, under higher atmospheric humidity and due to higher agglomeration rate, the concentration of larger aerodynamic (agglomerated) aerosols increases. On the other hand, under dry atmospheric conditions (when relative humidity is low) it is expected that the concentration of smaller aerodynamic charged particles to increase.

As such, another embodiment of the present invention considers the importance of the charging mechanism of the PM and incorporates additional electrostatic filtering in order to improve the filtration efficiency. This is applied specifically under dry atmospheric conditions when the finer PM size is more prevalent. If the overall charge of the aerosol particle is negligible or the aerodynamic size is large enough (>0.5 μm) then the mechanical filtration will sufficiently remove the particle from the airstream. Since very fine particles readily defuse into the surrounding environment and are susceptible to electrostatic forces under lower relative humidity (i.e. this is contrary to higher humidity conditions when particles grow larger due to water bridging and agglomeration), under dry conditions the small fine PM can be captured by electrostatic filters more efficiently.

It should be noted that fine dust tends to create a very compact dust layer on the surface of the filter elements and naturally drive-up system pressure drop, requiring frequent cleaning. However, once the larger particles are filtered out earlier in the gradient filtering system, the remaining particles being smaller with similar charge are collected on the surface of the filter element downstream. These “like” charged smaller particles tend to repel one another on the surface of the filter element, which creates a more porous dust layer. This partly reduces the clogging of the PM on the surface of the filters thus increasing the useful lifetime of the filter element.

As the concentration of collected dust-cake on the upstream side of the filter increases the pressure-drop on the downstream will also increase. This negatively affects the functioning of the filter (that is the filter lifetime). The filter lifetime is related to the surface area of the filter, the rate of air flow through the system, and the concentration of particles in the air stream. For any given system, combined effects of these factors define the pressure drop across the filter. Thus, for any given application, lessening the load of collected PM from the upstream side of the filter will lower the pressure-drop across the filter thereby extending life of the filter. This phenomenon would be more effective with gradient filtering arrangement (as opposed to only single filter mechanism) to capture a wide range of PM aerosols with different aerodynamic sizes. As such the present device incorporates a gradient arrangement in which filters with larger pore size are located in upstream of the filters with smaller pore size. In this way the larger aerosols are captured upstream of the device and subsequently the smaller particles are removed from the air stream by the relevant filters downstream of the airflow.

The criteria for the type of filter materials suitable for the gradient arrangement in present device include; (a) being porous with consistent pore-size. (b) being resistant to corrosion against acidic and alkaline contents of the airstream, (c) being resistant to the diluted industrial solvents and (d) have low electrostatic susceptibility (except for the pre-charge electrostatic filter which is not fixated permanently in the present device) and (e) have flexibility if the application requires the filters to be shaped either in the shape of coil or plate. Examples of such materials are (but not limited to) porous thermostable polyester derived material, ceramics, acrylic or aluminium materials.

While various embodiments of the present invention have been described above, it should be understood that they have been presented by way of example only, and not by way of limitation. It will be apparent to a person skilled in the relevant art that various changes in form and details can be made therein to suit different situations without departing from the spirit and scope of the present invention. Thus, the present invention should not be limited by any of the above-described exemplary embodiments.

### LIST OF REFERENCE NUMBERS USED IN THE SPECIFICATION TO ILLUSTRATE THE DETAILED DESCRIPTION OF THE INVENTION

1: Ceramic Filter Holder: High number of individual ceramic filter disks installed within each ceramic holder. A set level of the flowrate and large ceramic surface area are required to overcome the pressure differential caused by the ceramic micro size of the pores of the ceramic filters. The required flowrate is supplied by an internal suction fan located downstream side of the ceramic filter holders.
2: Twin Filter sets.
3: Ceramic Individual Filter discs are fixed in large numbers on the ceramic filter holders to create a large ceramic surface area.
4: Air-Void for even distribution of air.
5: Partition between the two twin ceramic filter holders to keep twin filters air-tight and separated from each other.
6: Filter Component 2 (12 μm pore size).
7: Filter component 3 (37 μm pore size).
8: Electrostatic (pre-charged) Filter.
9: Device outer protective capsule is made of a light-weight insulated aluminium.
10: Electric Valve located upstream side of filters.
11: Electric Valve coupled with a pressure-drop Sensor and is located downstream side of filters.
12: Inline Suction Fan located downstream of each filter.
13: Drain Pipe coupled with a specific electric valve and located at the bottom of each filter set.
14: Electric Spray Jets for filter cleaning.
15: Particulate Matter Sensor.
17: Front protective mesh to remove larger coarse sooth from the airstream.
18: Diameter of the non-ceramic filter components in a preferred embodiment of FIG. 3 is 0.3 meter.
19: Depth of the Ceramic Component in a preferred embodiment is 0.73 meter.
20: Height of the Ceramic Component in a preferred embodiment of FIG. 3 is 1.1 meter.
21: Diameter of the Ceramic Component in a preferred embodiment of FIG. 3 is 1.6 meter.
22: Diameter of the Air-Void of filter components with larger pore size of FIG. 4 being >0.4 meter.

1. An air purification system comprising a housing having an internally formed air stream flow path communicating between an inlet for incoming polluted air containing particulate material and an air outlet for emitting clean filtered air from which the particulate material has been removed, a collection system provided in the air stream flow path to collect the particulate material, said collection system comprising at least three stages of filters positioned in series in a gradient arrangement in filter pore size and each stage having two identical filter elements in parallel arrangement (twin filter elements), the said three stages of gradient arrangement comprising a first coarse filter set, a second medium filter set and a third fine filter set, each of the said twin filter elements incorporating a means for automated clogging detection, automated self-cleaning, automatically self-removing from the airflow path and automatically switching to the clean filter of the twin filter elements, a means for allowing filtering stages to ensure continuous airflow while the filter cleaning mechanism is being used and only a single filter element of the twin filter elements exposed to the air flow path within the housing and functioning at any time, wherein, in operation, once a filter element is clogged, it is taken off the filtration air flow pathway by triggering the self-cleaning mechanism and at the same time engaging the second twin filter element to take over the filtration process in that the passage of air through the filter housing is facilitated by a set of inline suction fans located downstream side of each filter stage of the air flow path where the passage of sufficient air volume through the fans is controlled by a pre-set airflow sensor connected to fans for automated adjustment of the air flow to ensure sufficient airflow constantly.

2. An air purification system as defined in claim 1 wherein the means for automated self-cleaning comprises:
pressure drop-activated sensors positioned on downstream side of the filters compared to the airflow direction;
a first set of electric valve coupled with a pressure-drop sensor located on the downstream side of the filters compared to the airflow direction;
a second set of electric valves located on the upstream side of the filters and in communication with the first set of valves wherein both electric valves and the sensor are activated once the filter surface is clogged by a signal from the sensor due to the pressure drop caused by the clogged filter and both valves being operated simultaneously in operation where both electric valve sets block the air pathway in an air-tight manner and take the clogged filter off the filtration process and engage the clean air filter at the same time while applying the automated operation to all three stages of the gradient filtration; and
a control panel connected and in automated communication with all electric parts for controlling the sensors and the electric valves.

3. (canceled)

4. A method of using an automated air purification system as defined in claim 2, said method comprising the steps of:
Isolating a clogged filter from the airflow path while simultaneously opening the air pathway to a parallel twin filter by operation of valves via a pressure control means.
Sending a signal by a pressure sensor to operate the valves when the upstream side of the filter surface is clogged thereby causing a pressure differential between the two faces of the filter
Opening of the twin-filter pathway which is positioned paralleled to the clogged filter by opening of the twin-filter valves positioned on the upstream and downstream of the twin-filter to allow uninterrupted airflow.
Simultaneously closing the valves positioned on the downstream and upstream of the clogged filter to isolate the clogged filter from the airflow pathway allowing for the cleaning of the clogged filter.
Ensuring continuity of the airflow when the clogged filter is isolated and removed from the pathway and the paralleled clean twin filter is engaged.
Controlling the electric valves via communication between the pressure sensors and the said electric valves via a control panel.
